(19) United States
(12) Patent Application Publication
(10) Pub. No.: US 2007/0199152 A1
(43) Pub. Date: Aug. 30, 2007

(54) Baby sleeping receptacle

(76) Inventor: Simon Basil Bluhdorn Askaroff, Eastbourne (GB)

Correspondence Address: DIEDERIKS & WHITELAW, PLC, #301, 12471 Dillingham Square, Woodbridge, VA, 22192, US

(21) Appl. No.: 11/699,329

(22) Filed: Jan. 30, 2007

(30) Foreign Application Priority Data
Jan. 30, 2006 (GB) 0601867.5

(51) Int. Cl. A47D 9/00; A47C 16/00; A47C 20/02; B68G 5/00

(52) U.S. Cl. 5/655; 5/101

(57) ABSTRACT

A baby sleeping receptacle constituted by a basket is formed from a synthetic material and provided with an array of through holes to enhance ventilation/breathability inside the basket.

### BACKGROUND OF THE INVENTION

1. Field of the Invention

This invention relates to receptacles in which new-born babies can sleep and/or be carried. It relates in particular to synthetic versions of the popular Moses Basket.

2. Discussion of Prior Art

Baskets for sleeping babies from birth up to about 6 months known, as Moses baskets, are well known in the art and conventionally made by weaving natural fibres such as wicker. However, these have several disadvantages. Firstly, since the baskets are hand-made their size and shape can be quite variable which leads to problems with the production of accessories such as bedding, stands etc. Secondly, they have only a limited life since they are difficult to clean and are prone to attack by small creatures which live off the natural fibres. Thirdly, there is a tendency for the woven fibres to split which can lead to a danger of them scratching or poking the baby. In the worst case the handle might fail during carrying leading to the baby being dropped.

A synthetic Moses basket has been proposed in GB-A-2383258 but the Applicant now recognises that this proposal can be improved.

### SUMMARY OF THE INVENTION

According to the present invention there is provided a baby sleeping receptacle formed from a synthetic material and provided with an array of through holes to enhance ventilation/breathability inside the basket.

Thus in accordance with the invention ventilation inside the receptacle is enhanced by the through holes. This offers an improvement over prior art baskets in terms of the improved ventilation. The adequacy of ventilation inside the basket cannot be over-emphasised, particularly in light of the observation that there is a tendency among some babies at least to sleep with their head very close to the side of their sleeping basket.

The basket may be constructed by weaving synthetic fibres with a weave that has sufficient gaps to form the appropriate through holes. Alternatively, and preferably, the receptacle is formed by moulding. In this way appropriate holes can be moulded into the walls of the receptacle.

The material of the receptacle could be any suitable inert synthetic material such as synthetic rubber but preferably comprises plastics, e.g. polyurethane, polythene or polyvinyl chloride.

The plurality of through holes need not all be the same size nor the same shape. They could be distributed evenly over the walls of the basket or may be more densely located in the vicinity of the upper end of the basket where the baby's head will be located.

The through holes preferably account for at least 1%, more preferably at least 5% of the surface area of the walls of the basket.

### BRIEF DESCRIPTION OF THE DRAWINGS

Some preferred embodiments of the invention will now be described, by way of example only, with reference to the accompanying drawings in which:

FIG. 1 is a side elevation of a baby sleeping basket according to a first embodiment of the invention; and

FIG. 2 is a side elevation of a second embodiment.

### DETAILED DESCRIPTION OF THE PREFERRED EMBODIMENTS

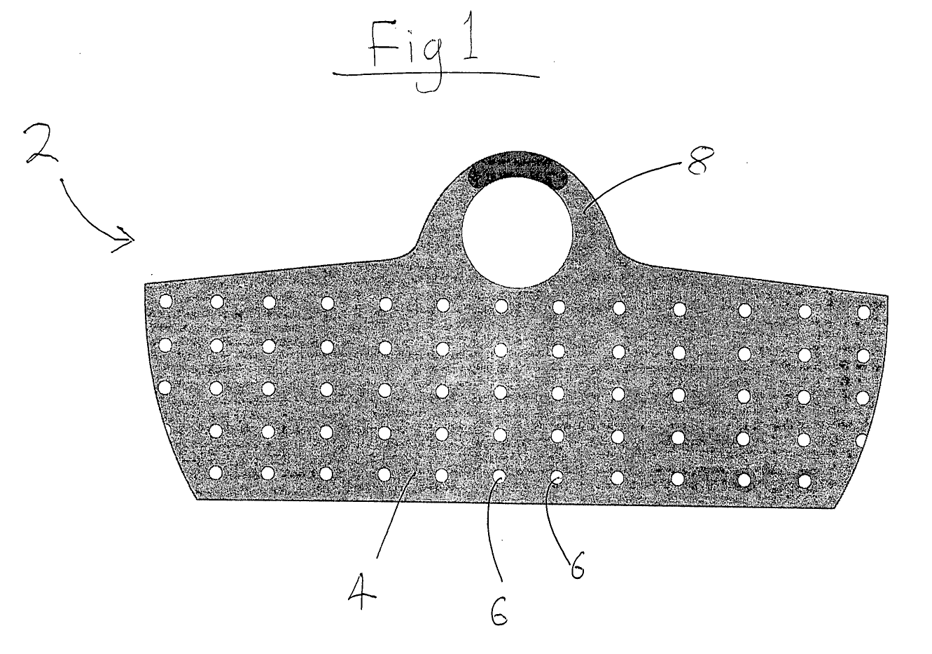

FIG. 1 shows a sleeping receptacle in accordance with the invention comprising a Moses basket 2. This is of conventional shape and average typical size for a Moses basket and thus is between 75-95 cm in length, 25-45 cm wide and 35-55 cm high. It is suitable for accommodating a baby until the age of approximately 6 months. Of course different shapes could be used.

As may be seen, the side wall 4 of the basket is provided with a rectangular grid of through holes 6 which are 5-10 mm in diameter. In this embodiment the holes make up approximately 1% of the surface area of the side wall 4.

An integrally moulded carry handle 8 may be seen midway along the upper edge of the side wall 4. As well as being aesthetically distinctive, the circular aperture defined by the handle 8 has been found to give a good connection strength between the handle and the rest of the basket by avoiding stress concentration points. The handles of conventional Moses baskets are known to be a point of weakness.

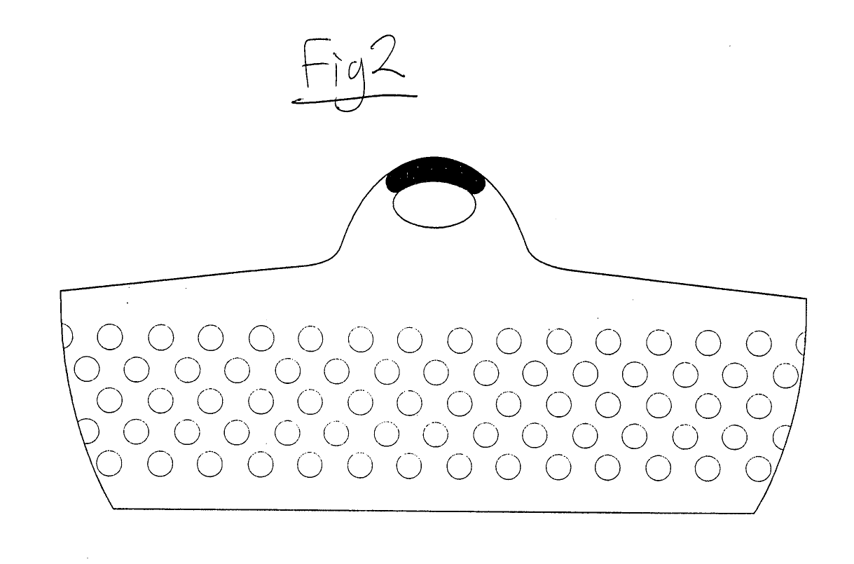

FIG. 2 shows a second embodiment of the invention. In this embodiment the through holes 10 are larger and arranged in a different pattern. The holes 10 have a diameter of approximately 20 mm and make up approximately 10% of the surface area of the side wall. The embodiment of FIG. 2 also shows an even stronger handle configuration 12.

In both embodiments the basket is preferably injection moulded from plastics such as polyurethane which makes the basket hygienic, easy to clean and resistant to deterioration and fading. Although not shown a hood or raised end could be provided.

The embodiments of the invention shown are merely examples and many variations and modifications are possible within the scope of the invention. For example, the through holes need not be provided all over the side wall of the basket but may instead be concentrated, or provided solely at a designated head end or at both ends to allow for reversibility. Although the embodiments shown have a regularly repeating pattern of through holes which may be preferred aesthetically this may not be necessary functionally. For example, a random or pseudo-random array of holes both in size and/or spacing could be provided as long as it would ensured that sufficient were provided in the vicinity of the intended head end of the basket to give the enhanced ventilation attributable to the invention.

The holes need not be circular as shown but could instead be square, rectangular, crescent shaped, triangular, or any other desired shape. They need not all be the same shape nor all the same size.

The receptacle could be made from any man made fibre or material.

Although described with reference to a preferred embodiment of the invention, it should be readily understood that various changes and/or modifications can be made to the invention without departing from the spirit thereof. In general, the invention is only intended to be limited by the scope of the following claims.

1. A baby sleeping receptacle formed from a synthetic material and provided with an array of through holes to enhance ventilation/breathability inside the basket.

2. A baby sleeping receptacle as claimed in claim 1 wherein the receptacle is moulded.

3. A baby sleeping receptacle as claimed in claim 2 wherein the receptacle is made from plastics.

4. A baby sleeping receptacle as claimed in claim 1 wherein the through holes account for at least 1% by area of the side wall of the receptacle.

5. A baby sleeping receptacle as claimed in claim 1 wherein the through holes account for at least 5% by area of the side wall of the receptacle.
